(19) United States
(12) Patent Application Publication
(10) Pub. No.: US 2012/0257774 A1
(43) Pub. Date: Oct. 11, 2012

(54) EAR PLUG FOR A HEARING AID AND A HEARING AID

(75) Inventors: Tina Ahlberg LARSEN, Birkerod (DK); Peter Nordland Jensen, Kastrup (DK); Nikolaj Hommelhoff Jensen, Copenhagen (DK); Lars Friis, Copenhagen (DK); Jorgen Mejner Olsen, Hillerod (DK); Torben Arnt, Frederiksberg (DK)

(73) Assignee: WIDEX A/S, Lynge (DK)

(21) Appl. No.: 13/528,280

(22) Filed: Jun. 20, 2012

Related U.S. Application Data
(63) Continuation-in-part of application No. PCT/EP2009/067659, filed on Dec. 21, 2009.

(51) Int. Cl. H04R 25/00

(52) U.S. Cl. 381/328; 381/312

(57) ABSTRACT

An earplug (100) for a hearing aid includes an ear canal body part (103) with a bore (106) and a sound output passage (107) in communication with the bore and leading to a sound output opening (105) and flanges (104a-d) surrounding said ear canal body part and adapted to engage a wall of an ear canal. The flanges are substantially disc shaped and have an axis of symmetry that is substantially parallel to the axis of symmetry of the bore of the ear canal body part. The invention further provides a hearing aid and a method of inserting a probe tube in an earplug.

### RELATED APPLICATIONS

The present application is a continuation-in-part of application No. PCT/EP2009/067659, filed on Dec. 21, 2009, and published as WO-A1-2011076246.

### BACKGROUND OF THE INVENTION

1. Field of the Invention

The present invention relates to an earplug for a hearing aid. The invention also relates to a hearing aid including an earplug. Moreover the invention relates to a method of insertion and fixation of a probe tube in an ear plug.

In the context of the present disclosure, a hearing aid should be understood as a small, battery-powered, microelectronic device designed to be worn behind or in the human ear by a hearing-impaired user. A hearing aid comprises one or more microphones, a battery, a microelectronic circuit comprising a signal processor, and an acoustic output transducer. The signal processor is preferably a digital signal processor. The hearing aid is enclosed in a casing suitable for fitting behind or in a human ear.

As the name suggests, Behind-The-Ear (BTE) hearing aids are worn behind the ear. To be more precise, an electronics unit comprising a housing containing the major electronics parts thereof is worn behind the ear. An earplug for emitting sound to the hearing aid user is worn in the ear, e.g. in the ear canal. In a traditional BTE hearing aid, a sound tube is used because the output transducer, which in hearing aid terminology is normally referred to as the receiver, is located in the housing of the electronics unit. In some modern types of hearing aids a conducting member comprising electrical conductors is used, because the receiver is placed in the earplug in the ear. Such hearing aids are commonly referred to as Receiver-In-The-Ear (RITE) hearing aids. In a specific type of RITE hearing aids the receiver is placed inside the ear canal. This is known as Receiver-In-Canal (RIC) hearing aids.

In-The-Ear (ITE) hearing aids are designed for arrangement in the ear, normally in the funnel-shaped outer part of the ear canal. This type of hearing aid requires a very compact design in order to allow it partly to be arranged in the ear canal, partly to house the components necessary for operation of the hearing aid, such as microphones, a battery, a microelectronic circuit comprising a signal processor, and an acoustic output transducer. In a specific type of ITE hearing aids the hearing aid is positioned completely inside the ear canal. This is known as Completely-In-Canal (CIC) hearing aids.

On a general level earplugs for hearing aids may be categorized into two groups. The first group contains the so called custom earplugs that are characterized by being individually adapted to the user. The second group contains the so called instant fit earplugs that are designed to passively adapt to the ear of the user when inserted. Instant fit earplugs are advantageous in that a hearing aid fitter can have them in stock.

Hereby the hearing aid user does not have to wait while the earplugs are manufactured, as is the case for custom earplugs. However, instant fit earplugs may for some users be uncomfortable to wear. For other users the earplugs may not provide a sufficiently accurate fit, in order to secure a low acoustical leakage.

2. The Prior Art

WO-A2-99/07182 discloses an acoustic coupler that is detachably secured to a receiver assembly for deep insertion into an individual's ear canal. The acoustic coupler provides a semirigid, thin walled, cylindrical coupling sleeve that is adapted to be attached over a cylindrical receiver assembly. A conforming sealing material is attached diametrically over the coupling sleeve to fit comfortably and to seal the individual's ear canal acoustically. The coupling sleeve is substantially concentric to the receiver assembly for a highly space efficient interface and a user friendly replacement method.

The fast growth of childrens ear canal makes it difficult to provide a custom earplug that fits correctly. A custom earplug is made from an imprint of the ear, which typically is made by a fitter. Since the ear canal of the child grows quite fast, a new mould is normally made a little bit too big, so as to fit the ear for a longer period, since it is a costly and time consuming process to consult a fitter and produce a new mould. The traditional process of making a custom earplug with a perfect fit is thus not always suitable for hearing aids for children. Consequently, the hearing impaired child almost never experiences an earplug and a hearing aid that fits and functions perfectly.

The sound pressure level delivered by a hearing aid to the ear drum of a user depends on the geometry and dimensions of the ear canal. The fast growth of childrens ear canal therefore results in significant variations over time of the sound pressure level delivered by a hearing aid to the ear drum of a child. It is well known in the art to apply Real-Ear-to-Coupler Difference (RECD) measurements for predicting the hearing aid performance in a real ear. The principles of RECD measurements are further described in e.g. the article “Procedure for predicting real-ear hearing aid performance in young children.” by Moodie, K. S., Seewald, R. C., & Sinclair, S. T. in American Journal of Audiology, 3(1), 23-31, (1994).

Today it is a difficult task to carry out the measurements required for predicting the hearing aid performance.

It is therefore a feature of the present invention to overcome at least these drawbacks and provide a type of instant fit earplug that provides a good fit for a range of different ears, hereby providing a comfortable earplug with a low acoustical leakage.

It is another feature of the present invention to provide an instant fit earplug that is adapted for easy insertion and fixation of a probe tube.

It is still another feature of the present invention to provide a hearing aid incorporating such an earplug.

It is yet another feature of the present invention to provide a method of insertion and fixation of a probe tube in an earplug.

### SUMMARY OF THE INVENTION

The invention, in a first aspect, provides an earplug for a hearing aid comprising an ear canal body part comprising a bore, and a sound output passage in communication with the bore and leading to a sound output opening, and a first flange and a second flange, each of said flanges extending from said ear canal body part and adapted to engage a wall of an ear canal, each of said flanges being substantially disc shaped and generally rotationally symmetric about an axis that is substantially parallel to the axis of the bore of the ear canal body part, wherein the diameters of the flanges increase progressively with the distance of the respective flange from the sound output opening, wherein said first flange comprises a slit adapted for relieving a pressure difference across the earplug and for permitting insertion and fixation of a probe tube, and wherein said second flange comprises an insertion opening adapted for the insertion of a probe tube. This provides an earplug that provides a good fit in a wide range of different ears, while being at the same time comfortable to wear.

The invention, in a second aspect, provides a hearing aid comprising an earplug, said earplug having: an ear canal body part comprising a bore, and a sound output passage in communication with the bore and leading to a sound output opening, and a first flange and a second flange, each of said flanges extending from said ear canal body part and adapted to engage a wall of an ear canal, each of said flanges being substantially disc shaped and generally rotationally symmetric about an axis that is substantially parallel to the axis of the bore of the ear canal body part, wherein the diameters of the flanges increase progressively with the distance of the respective flange from the sound output opening, wherein a first flange comprises a slit adapted for relieving a pressure difference across the earplug and for permitting insertion and fixation of a probe tube, and wherein said second flange comprises an insertion opening adapted for the insertion of a probe tube.

This provides a hearing aid that is specifically adapted for easy insertion and fixation of a probe tube at the ear plug.

The invention, in a third aspect, provides a method for insertion and fixation of a probe tube in an ear plug comprising the steps of providing the earplug, said earplug having a first and a second flange extending from an ear canal body part of the earplug, said flanges being adapted to engage a wall of an ear canal and said first flange comprising a slit and said second flange comprising an insertion opening, inserting the probe tube through said slit the first flange and through said insertion opening.

This provides a method that allows RECD measurements to be carried out in a simple and reproducible manner.

Further advantageous features appear from the dependent claims.

Still other features of the present invention will become apparent to those skilled in the art from the following description wherein the invention will be explained in greater detail.

### BRIEF DESCRIPTION OF THE DRAWINGS

By way of example, there is shown and described a preferred embodiment of this invention. As will be realized, the invention is capable of other embodiments, and its several details are capable of modification in various, obvious aspects all without departing from the invention. Accordingly, the drawings and descriptions will be regarded as illustrative in nature and not as restrictive. In the drawings:

FIG. 1 illustrates a side plan view of an earplug according to a first embodiment of the invention;

FIG. 2 illustrates a front plan view of the earplug according to the first embodiment of the invention;

FIG. 3 illustrates a cross sectional view of the earplug according to the first embodiment of the invention;

FIG. 4 illustrates a side plan view of an earplug according to a second embodiment of the invention;

FIG. 5 illustrates a front plan view of the earplug according to the second embodiment of the invention;

FIG. 6 illustrates a cross sectional view of the earplug according to the second embodiment of the invention;

FIG. 7 illustrates a perspective view of an earplug according to a third embodiment of the invention;

FIG. 8 illustrates a perspective view of the earplug, according to the third embodiment of the invention, with a probe tube inserted;

FIG. 9 illustrates a hearing aid with an earplug according to the second embodiment of the invention; and

FIG. 10 illustrates a hearing aid with an earplug according to a fourth embodiment of the invention.

### DETAILED DESCRIPTION OF THE INVENTION

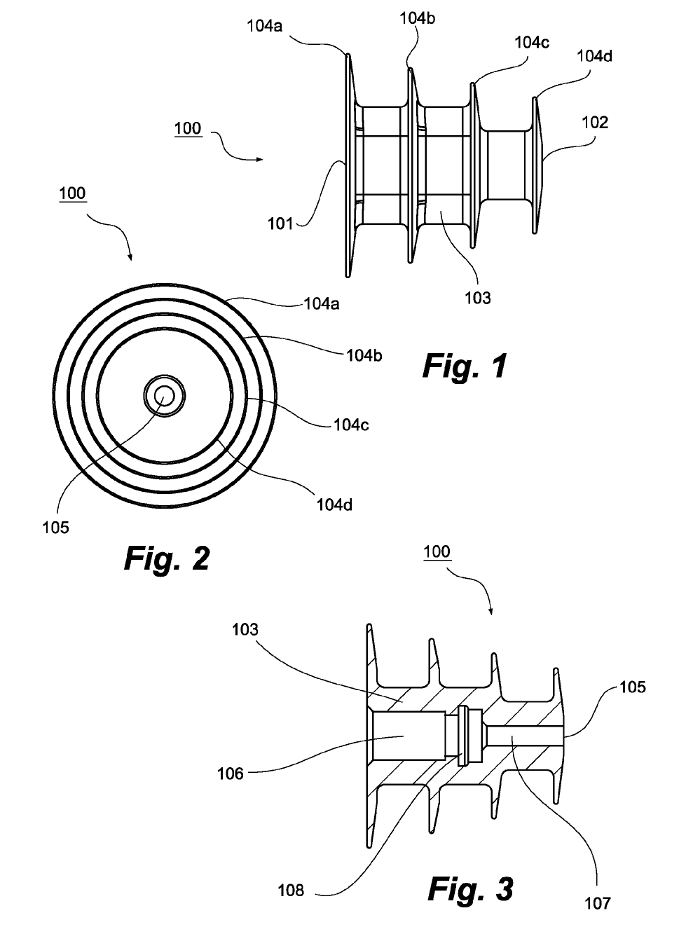

Reference is first made to FIG. 1, which illustrates an earplug 100 according to a first embodiment of the invention. The earplug 100 includes a proximal end 101, a distal end 102 and an ear canal body part 103. The earplug further includes four disc shaped flanges or rims 104a, 104b, 104c and 104d.

Reference is now made to FIG. 2, which illustrates a front plan view of the earplug 100 according to the first embodiment of the invention. The distal end 102 includes sound output opening 105.

Reference is now made to FIG. 3, which shows a cross sectional view of the earplug according to the first embodiment of the invention. The body part 103 includes a central bore 106 and a sound output passage 107 leading to the sound output opening 105 in the distal end 102 of the earplug. The earplug further comprises locking means 108 adapted for snap fitting to a receiver housing (not shown), hereby rendering the ear plug adapted for use with a RITE or RIC hearing aid. For further details about the fitting of the receiver in the earplug, reference may be had to WO-A1-2008095505.

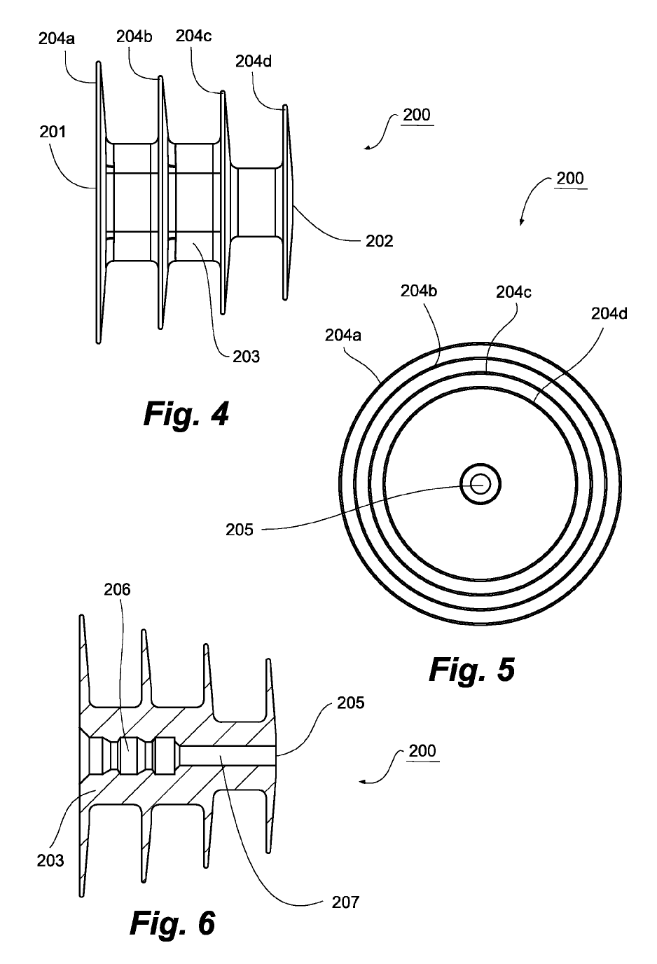

Reference is now made to FIG. 4, which shows an earplug 200 according to a second embodiment of the invention. The earplug 200 includes a proximal end 201, a distal end 202 and a body part 203. The earplug further includes four disc shaped flanges or rims 204a, 204b, 204c and 204d.

Reference is now made to FIG. 5, which shows a front plan view of the earplug 200 according to the second embodiment of the invention. The distal end 202 includes sound output opening 205.

Reference is now made to FIG. 6, which shows a cross sectional view of the earplug according to the second embodiment of the invention. The body part 203 includes a central bore with locking means 206 and a sound output passage 207 leading to the sound output opening 205 in the distal end 202 of the earplug. The locking means 206 are adapted for receiving a sound tube, hereby rendering the ear plug 200 adapted for use with a traditional BTE hearing aid. Suitable designs of locking means are further described in WO-A1-2007006302.

Variations of these embodiments with more than four flanges or less than four flanges will be obvious to those skilled in the art.

In an embodiment the diameters of the flanges decrease with the distance from the proximal end. According to an embodiment the relative decrement in flange diameter is constant and in the range of 1-2 mm, preferably 1.5 mm. In other embodiments the decrement of flange diameter needs not to be constant.

According to an embodiment the largest flange diameter is 15 mm. In another embodiment the smallest flange diameter is 5 mm.

According to an embodiment the spacing between the flanges is constant. The spacing may be in the range of 1-4 mm, preferably around 3 mm. The total length of the earplug is in the range of 6-12 mm, preferably around 10 mm. In other embodiments the spacing between the flanges need not be constant.

According to an embodiment the flange thickness is uniform and 0.5 mm, e.g. the thickness may be in the range between 0.3 mm and 1.5 mm, preferably between 0.4 mm and 0.8 mm. According to another embodiment the flange thickness is substantially uniform and the largest distance, along the axis of the bore of the ear canal body part, between a point on the outer circumference of a flange and a point on the same flange adjacent to the ear canal body part is about 0.5 mm. The largest distance may be in the range between 0.3 mm and 1.5 mm, preferably between 0.4 mm and 0.8 mm.

It has been found successful with flanges wherein the distance, perpendicular to the axis of the bore of the ear canal body part, between a point on the outer circumference of a flange and a point on the same flange adjacent to the ear canal body part is at least two times the smallest flange thickness, alternatively at least three times the smallest flange thickness.

It has been found that earplugs with disc shaped, or substantially disc shaped, flanges, according to various embodiments of the invention, in many cases provide a better fit and higher acoustical damping than conventional earplugs with flanges of spherical or conic shape. This is believed to be a result of flanges of spherical or conic shape having increased tendency to collapse away from the wall of the ear canal when exposed to a compressive pressure (from the ear canal walls) in the plane perpendicular to the flange axis of symmetry. This is a result of the relatively lower mechanical strength of the flanges of spherical or conic shape compared to the disc shaped flanges, when considering a compressive force in the above mentioned plane.

According to an embodiment the flange axis of symmetry is parallel to the axis of the bore of the ear canal body part. In another embodiment the flange axis of symmetry is substantially parallel to the axis of the bore of the ear canal body part.

It has been found that this type of earplug adapts so well to the ear canal that a significant pressure difference builds up across the earplug and between the ambient air and the inner part of the ear canal close to the ear drum when the earplug is inserted and removed. The hearing aid user may experience this to be uncomfortable. According to a preferred embodiment a slit is therefore cut in each of the flanges. Hereby the build-up of a pressure difference is avoided. Somewhat surprisingly the presence of the slits does not affect the low acoustical leakage of the earplug.

It is a specific advantage of this type of earplug, according to an embodiment of the invention, that the distance, along the axis of the bore of the ear canal body part, between the sound output opening and the flange closest to the distal end can be very short. This provides a small residual volume in front of the eardrum, which is advantageous with respect to the sound pressure level (SPL) that can be delivered to the eardrum and with respect to suppression of occlusion.

In an embodiment the earplug is provided with a vent. In a further embodiment the vent is provided by cutting a vent hole in each of the flanges, where the position of a vent hole is substantially directly above or below the corresponding vent hole in the neighbouring flanges. In other embodiments the position of a vent hole is displaced relative to the corresponding vent hole in the neighbouring flanges. Hereby the characteristics of the sound transmission through the vent are changed, i.e. the acoustical damping is increased, while the traditional vent effect is maintained such that e.g. a high humidity can be avoided in the ear canal. According to an embodiment two vent holes are cut in each of the flanges, symmetrically around the centers of the flanges, and the line connecting the two vent holes in the first flange is perpendicular to the corresponding lines connecting the two vent holes in each of the remaining flanges.

According to an embodiment the earplug is made in silicone rubber. The chosen material is preferably soft and elastic thus rendering the earplug part easy to insert and comfortable to wear while maintaining the low acoustical leakage. The preferred material may have a Shore A hardness in the interval between 15 and 30, preferably between 23 and 27. The skilled person will realize that other materials such as a thermoplastic elastomer (TPE) could also be used.

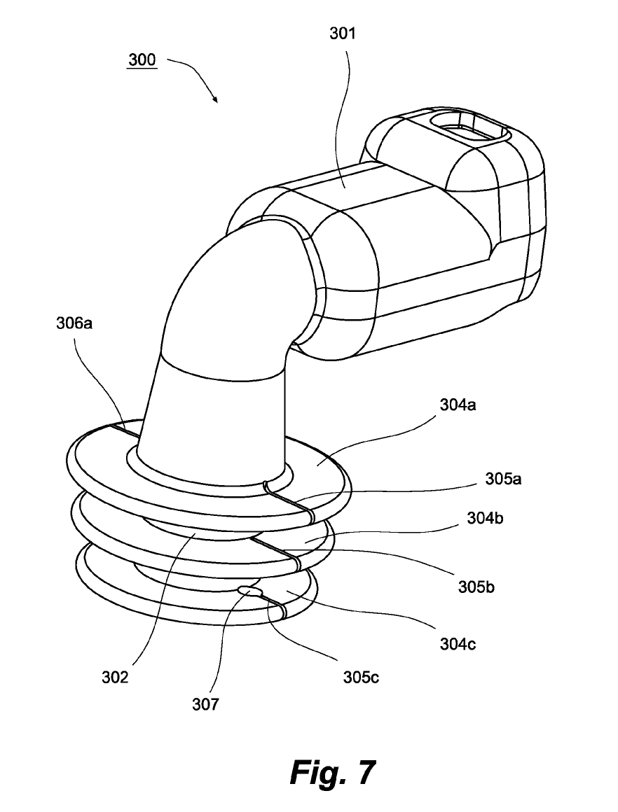

Reference is now made to FIG. 7 which shows an earplug 300 according to a third embodiment of the invention. The earplug 300 includes a sleeve member 301 for a receiver module of a hearing aid of the receiver-in-the-ear (RITE) type. The sleeve member is further described in unpublished patent application PCT/DK2008/000357, filed on 10 Oct. 2008 and published as WO2010040351. The earplug 300 includes a main earplug body part 302, wherein the body part 302 includes a central bore (not shown) and a sound output passage (not shown) leading to a sound output opening (not shown). The earplug further includes three disc shaped flanges or rims 304a, 304b and 304c. Two slits have been cut into each of the flanges. The slits illustrated in the figure are denoted 305a, 305b, 305c and 306a (not shown in the figure is an additional slit in the flange 304b and in the flange 304c). The two slits in each of the flanges have been cut symmetrically around the center of the flange. The slits in each of the flanges have been cut directly above or below the corresponding slits of the neighbouring flanges. The flange nearest to the distal end includes a hole 307 adapted for insertion and fixation of a probe tube.

This earplug allows a probe tube for e.g. RECD measurements to be inserted and fixated in the earplug in an easy and convenient manner.

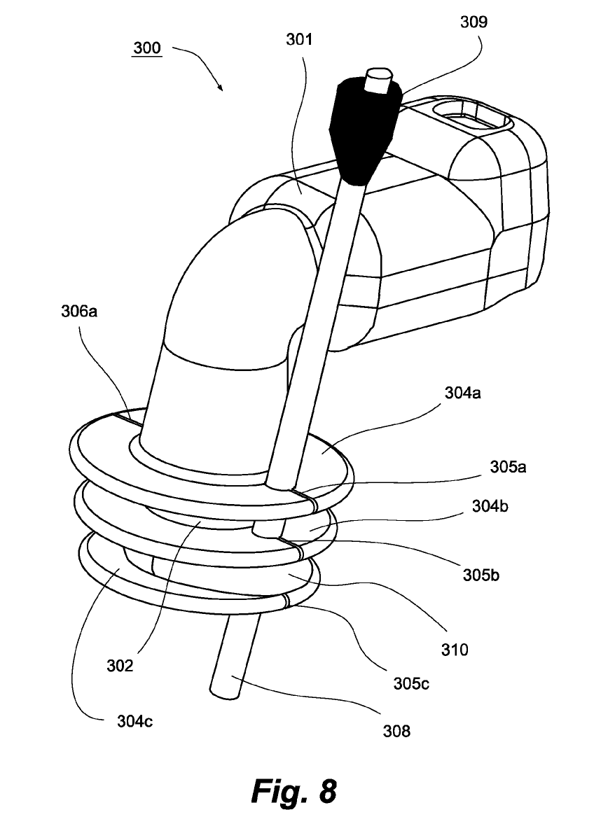

Reference is now made to FIG. 8 which shows the earplug 300 according to the third embodiment of the invention with a probe tube 308 inserted. The probe tube is shown together with a marker 309 and an elastic ring 310.

It is a specific advantageous feature of the earplug 300 that a low acoustical leakage is provided together with the possibility of easy and convenient insertion and fixation of a probe tube. This advantageous combination of features is at least partly a result of the configuration with the slits in the flanges, because the slits in a first instance allow a probe tube to be inserted through the earplug, whereby e.g. the cumbersome method of attaching the probe tube to the outside of the earplug is avoided, while at the same time providing highly reproducible results. In a second instance the slits allow the earplug to function as a closed earplug (i.e. without a vent), as soon as the probe tube has been removed.

It is a further specific advantageous feature of the earplug 300 according to the invention, that the fit to the ear canal is so precise that it helps fixating the sleeve member.

In a method embodiment according to the invention an RECD measurement is carried out by mounting the marker 309 around the probe tube, determining the desired insertion depth of the probe tube, fixating the marker in such a way that the desired insertion depth is obtained when the marker is aligned with the tragus of the external ear, inserting the probe tube in the earplug through the slits 305a and 305b in the flanges 304a and 304b respectively and through the opening 307 in the flange 304c to such a depth that the marker 309 is aligned with the surface of the sleeve member 301 that is adapted to face away from the ear when inserted in an ear, snapping the elastic ring 310 around the probe tube in the space between the flanges 304b and 304c hereby fixating the insertion depth of the probe tube and the alignment of the probe tube along the outer surface of the earplug body part 302.

According to a preferred method embodiment of the invention for carrying out an RECD measurement the probe tube is inserted at incisura intertragica between the tragus and the antitragus. A RITE type earplug, according to a corresponding embodiment of the invention (not illustrated), has two slits in each of the flanges and two holes in one of the flanges, wherein the slits and the holes, respectively, are cut symmetrically about the center of the corresponding flanges. This ensures that only a single earplug 300 of the RITE type is necessary for allowing the probe tube to be inserted at incisura intertragica in both the left and the right ear.

According to an embodiment the earplug part is made in silicone rubber. The skilled person will realize that other materials could be used, e.g. a thermoplastic elastomer (TPE). The preferred material is preferably soft and elastic thus rendering the earplug part easy to insert and comfortable to wear. The material selected may have a Shore A hardness in the interval between 18 and 30, preferably between 23 and 27.

According to embodiments wherein the earplug is adapted for hearing impaired children less than 6 years old, the flange diameters are in the interval between 5 and 12 mm, the difference in flange diameter between the smallest and largest flange for a given sleeve member is in the interval between 1 and 2 mm, the flange thickness is substantially uniform and around 0.5 mm, and the distance between the flanges along the axis of symmetry of the central bore is in the interval between 1 and 2 mm, preferably 1.25 mm. Hereby is provided an earplug, where the part adapted to engage the ear canal wall part may have a length, along the axis of symmetry of the central bore, in the interval between 3 and 5 mm, preferably between 3.5 mm and 4.5 mm.

The outer diameter of the body part is between 3 and 5 mm, preferably 3.5 mm.

These embodiments give a hearing aid fitter the opportunity to provide an instant fit earplug for a wide range of children, while only having to maintain a limited stock of different instant fit earplugs. The earplugs are comfortable to wear and provide a low acoustical leakage, and it has been found that these advantages are maintained for a long duration of time while the child wearing the earplug is growing.

It is a specific advantage of the earplug according to the invention that the distance, along the axis of the central bore, between the flange nearest to the proximal end and the flange nearest to the distal end can be very short. According to an embodiment the distance is only 2.5 mm. This is especially advantageous for earplugs designed for children or for deep fitting in the ear canal.

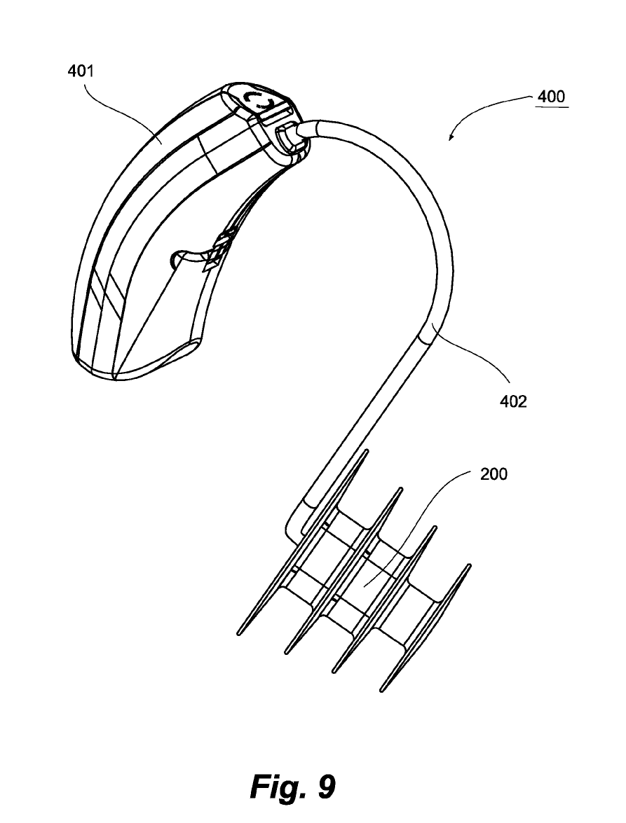

Reference is now made to FIG. 9 which shows a traditional BTE hearing aid 400 including a housing 401, a sound tube 402 and an earplug 200 according to the second embodiment of the invention.

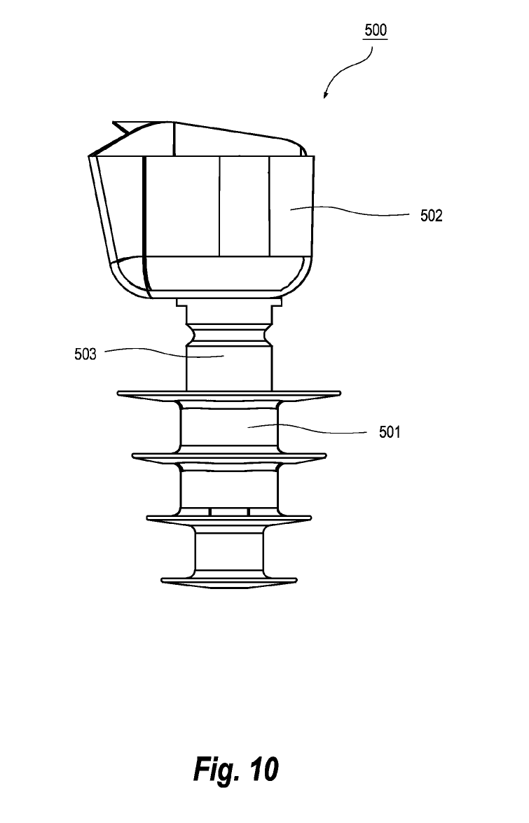

Reference is now made to FIG. 10 which shows a Completely-In-Canal (CIC) hearing aid 500 having an earplug 501 according to a fourth embodiment of the invention. The CIC hearing aid basically includes three parts: a housing part 502 that contains the major electronics parts with the exception of the output transducer, the earplug 501 that contains the output transducer, and a flexible joint 503 that contains electrical conductors for providing the electrical connection between the housing part 502 and the earplug part 501 and allows these two parts to bend relative to each other whereby the overall shape of the CIC hearing aid can change. The earplug part 501 is especially advantageous for this type of CIC hearing aid, because the short distance required between the flange nearest to the proximal end and the flange nearest to the distal end provides a short earplug that is well suited for deep fitting in the ear canal.

Generally the earplug according to the invention may be adapted for use with any type of hearing aid.

Other modifications and variations of the structures and procedures will be evident to those skilled in the art.

We claim:

1. An earplug for a hearing aid comprising:
an ear canal body part comprising a bore, and a sound output passage in communication with the bore and leading to a sound output opening, and
a first flange and a second flange, each of said flanges extending from said ear canal body part and adapted to engage a wall of an ear canal, each of said flanges being substantially disc shaped and generally rotationally symmetric about an axis that is substantially parallel to the axis of the bore of the ear canal body part, wherein the diameters of the flanges increase progressively with the distance of the respective flange from the sound output opening, wherein said first flange comprises a slit adapted for relieving a pressure difference across the earplug and for permitting insertion and fixation of a probe tube, and wherein said second flange comprises an insertion opening adapted for the insertion of a probe tube.

2. The earplug according to claim 1, wherein the largest distance, along the axis of the bore of the ear canal body part, between a point on the outer circumference of at least one of said flanges and a point on the same flange adjacent to the ear canal body part is in the range between 0.3 mm and 1.5 mm.

3. The earplug according to claim 1, wherein the largest distance, along the axis of the bore of the ear canal body part, between a point on the outer circumference of at least one of said flanges and a point on the same flange adjacent to the ear canal body part is in the range between 0.4 mm and 0.8 mm.

4. The earplug according to claim 1, wherein the distance, perpendicular to the axis of the bore of the ear canal body part, between a point on the outer circumference of at least one of said flanges and a point on the same flange adjacent to the ear canal body part is at least two times the smallest flange thickness.

5. The earplug according to claim 1, wherein the distance, perpendicular to the axis of the bore of the ear canal body part, between a point on the outer circumference of at least one of said flanges and a point on the same flange adjacent to the ear canal body part is at least three times the smallest flange thickness.

6. The earplug according to claim 1, wherein the length of said ear canal body part, along the axis of the bore of the ear canal body part, is less than 4 mm.

7. The earplug according to claim 1, wherein the earplug is manufactured in an injection molding process.

8. The earplug according to claim 1, wherein said second flange is arranged adjacent the sound output opening.

9. The earplug according to claim 8, wherein said second flange comprises a second slit, which intersects the circumference of the opening.

10. The earplug according to claim 9, wherein said first slit extends to opposing sides of said first flange, and wherein said second slit is cut directly above said first slit.

11. The earplug according to claim 1, wherein said first flange comprises a first vent hole, and wherein said second flange comprises a second vent hole, which is displaced relative to the position of said first vent hole.

12. A hearing aid comprising an earplug, said earplug having: an ear canal body part comprising a bore, and a sound output passage in communication with the bore and leading to a sound output opening, and a first flange and a second flange, each of said flanges extending from said ear canal body part and adapted to engage a wall of an ear canal, each of said flanges being substantially disc shaped and generally rotationally symmetric about an axis that is substantially parallel to the axis of the bore of the ear canal body part, wherein the diameters of the flanges increase progressively with the distance of the respective flange from the sound output opening, wherein a first flange comprises a slit adapted for relieving a pressure difference across the earplug and for permitting insertion and fixation of a probe tube, and wherein said second flange comprises an insertion opening adapted for the insertion of a probe tube.

13. The hearing aid according to claim 12, comprising a housing part and a flexible joint adapted for holding together the housing part and earplug.

14. The hearing aid according to claim 13, comprising a signal processor in the housing part, and an output transducer in the earplug, wherein the flexible joint comprises electrical conductors for connecting said signal processor with said output transducer.

15. The hearing aid according to claim 12, wherein the earplug comprises a sleeve member adapted for being placed in the outer part of an ear and for holding and fixating an output transducer.

16. The hearing aid according to claim 15, wherein the earplug comprises a sleeve member with a surface adapted for having a distance to said first flange that is substantially the same as the distance between said first flange and a specific part of the external ear, where said distance is to be measured along a probe tube inserted in the earplug.

17. The hearing aid according to claim 16, wherein said surface faces towards the ambient when said earplug is inserted in an ear, and wherein said specific part of the external ear is the tragus.

18. A method of inserting a probe tube in an earplug, comprising the steps of:
providing the earplug, said earplug having a first and a second flange extending from an ear canal body part of the earplug, said flanges being adapted to engage a wall of an ear canal and said first flange comprising a slit and said second flange comprising an insertion opening,
inserting the probe tube through said slit the first flange and through said insertion opening.

19. The method of inserting the probe tube in the earplug according to claim 18, wherein the insertion depth of the probe tube in the earplug is controlled by the steps of:
mounting a marker around the probe tube,
determining a characteristic probe tube length corresponding to a desired insertion depth of the probe tube,
fixating the marker in such a way that the distance between the marker and the end of the probe tube corresponds to said characteristic probe tube length,
inserting the probe tube through said slit and through said insertion opening, and
aligning the marker with a surface of the earplug.

20. The method of inserting the probe tube in the earplug according to claim 19, comprising the step of:
snapping an elastic ring around the probe tube in the space between the two flanges hereby fixating the insertion depth of the probe tube and the alignment of the probe tube along the outer surface of the earplug body part.
